(19) United States
(12) Patent Application Publication
(10) Pub. No.: US 2006/0075631 A1
(43) Pub. Date: Apr. 13, 2006

(54) Pick and place machine with improved component pick up inspection

(76) Inventors: Steven K. Case, St. Louis Park, MN (US); Paul R. Haugen, Bloomington, MN (US); David W. Duquette, Minneapolis, MN (US); David D. Madsen, Lakeland, MN (US); David Fishbaine, Minnetonka, MN (US); Lance K. Fisher, Excelsior, MN (US); Timothy G. Badar, St. Paul, MN (US); Swaminathan Manickam, Wilmington, MA (US)

Correspondence Address: WESTMAN, CHAMPLIN & KELLY, P.A.;International Centre, Suite 1400, 900 Second Avenue South, Minneapolis, MN, 55402-3319, US

(21) Appl. No.: 11/243,523

(22) Filed: Oct. 4, 2005

Related U.S. Application Data
(60) Provisional application No. 60/615,931, filed on Oct. 5, 2004.

(51) Int. Cl. B23P 21/00

(52) U.S. Cl. 29/709; 29/740; 29/743; 29/721

(57) ABSTRACT

Embodiments of the present invention improve upon component level inspection performed by pick and place machines. Such improvements include inspecting the pick operation in pick and place machines by collecting images of the pick event inside the machine and identifying errors as they happen. By detecting and displaying this information as it generated on the machine, the operator or machine can take prompt and effective corrective actions.

### CROSS REFERENCE TO RELATED APPLICATIONS

This application claims priority to U.S. provisional patent application Ser. No. 60/615,931, filed Oct. 5, 2004 entitled PICK AND PLACE MACHINE WITH IMPROVED COMPONENT PICK UP INSPECTION.

### COPYRIGHT RESERVATION

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

Pick and place machines are generally used to manufacture electronic circuit boards. A blank printed circuit board is usually supplied to the pick and place machine, which then picks electronic components from component feeders, and places such components upon the board. The components are held upon the board temporarily by solder paste, or adhesive until a subsequent step in which the solder paste is melted, or the adhesive is fully cured.

Pick and place machine operation is challenging. Since machine speed corresponds with throughput, the faster the pick and place machine runs, the less costly the manufactured board. Additionally, placement accuracy is extremely important. Many electrical components, such as chip capacitors and chip resistors are relatively small and must be accurately placed on equally small placement locations. Other components, while larger, have a significant number of leads or conductors that are spaced from one another at a relatively fine pitch. Such components must also be accurately placed to ensure that each lead is placed upon the proper pad. Thus, not only must the machine operate extremely fast, but it must also place components extremely accurately.

In order to enhance the quality of board manufacture, fully or partially populated boards are generally inspected after the placement operation(s), both before and after solder reflow, in order to identify components that are improperly placed or missing or any of a variety of errors that may occur. Automatic systems that perform such operation(s) are highly useful in that they help identify component placement problems prior to solder reflow allowing substantially easier rework or identify defective boards after reflow that are candidates for rework. One example of such a system is sold under the trade designation Model KS Flex available from CyberOptics Corporation of Golden Valley, Minn. This system can be used to identify such problems as alignment and rotation errors; missing and flipped components; billboards; tombstones; component defects; incorrect polarity; and wrong components. Identification of errors pre-reflow provides a number of advantages. Rework is easier; closed-loop manufacturing control is facilitated; and less work in-process exists between error generation and remedy. While such systems provide highly useful inspection, they do consume plant floor-space as well as programming time, maintenance efforts and the like.

One relatively recent attempt to provide the benefits of after-placement inspection located within a pick a place machine itself is disclosed in U.S. Pat. No. 6,317,972 to Asai et al. That reference reports a method for mounting electric components where an image of a mounting location is obtained prior to component placement, and compared with an image of the mounting location after component placement to inspect the placement operation at the component level. While the disclosure of Asai et al. marks one attempt to employ in-machine component level inspection to inspect the component placement operation, the process of picking up a component remains a challenge and a major contributor to the quality of the overall operation of the pick and place machine.

Picking up a component requires the placement head to be positioned over the pick up point for the target component. Once the nozzle is positioned, it is lowered to a point just above the component and a vacuum is applied through the nozzle which sucks the component up and temporarily attaches it to the end of the nozzle. Each component is positioned at its pick point by a component feeder mechanism. Typical feeder mechanisms include tape feeders, vibratory feeders and tray feeders. When required to configure a pick and place machine to assemble a new workpiece, an operator will insert the component feeders into their positions following an ordering scheme determined by the pick and place machine's program. Additionally, identification marks, such as barcodes, may be located on the feeder mechanisms to ensure the proper feeder is located in the proper position and sequence in the pick and place machine. Once a component is picked up by the nozzle, the feeder mechanism must move another component into the pick position.

If the component pick operation is not successful, defective workpieces are produced. Defects on workpieces that are known to be caused by bad pick operations are tombstoned components, missing components, wrong components, wrong component polarity, and misplaced components. Further, defects are caused by operators loading feeders into incorrect positions or allowing feeders to run out of components; defective or broken feeders, component tapes and nozzles; incorrectly programmed nozzle pick heights; and incorrectly position components.

### SUMMARY OF THE INVENTION

Embodiments of the present invention improve upon component level inspection performed by pick and place machines. Such improvements include inspecting the pick operation in pick and place machines by collecting images of the pick event inside the machine and identifying errors as they happen. By detecting and displaying this information as it generated on the machine, the operator or machine can take prompt and effective corrective actions.

In accordance with one embodiment of the present invention, images are taken of the pick location before and after the pick up of the component, processed and displayed to the operator shortly after the pick has completed. In addition to the images, pick-related measurements can be displayed to the operator to assist in the diagnosis of problems as they occur. Pick-related measurements or parameters include the presence and absence of a component to be picked in the correct pick position; the presence or absence of a component on the nozzle after pick; the correct orientation and polarity of the component before pick up; the correct position of the component after pick on the nozzle; the condition of the nozzle; the height of the nozzle at the time of component pick up; and the condition and movement of the feeder during the pick operation. These pick-related measurements and parameters may also be used to control the operation of the pick and place machine by directing the machine to stop on a detected pick error, to re-pick the component if a defective pick operation is detected, or otherwise generate an error message that can be acted upon or stored by the pick and place machine or other external control system.

In accordance with another embodiment of the present invention, images and pick-related parameters extracted from such images can be collected stored for later review. Pick-related process parameters can be compared and trend analysis can occur over the assembly of multiple workpieces. A knowledge database can be established to track symptomatic images and corrective actions taken as a result of the displayed symptoms. Further, the images and data collected in the database can be shared with experts located away from the pick and place machine to diagnosis and correct problems. One example of such location is rework stations found at the end of the production line or the images can be sent to the pick and place machine vendor so that the vendor's experts can be enlisted in determining the cause of the problems.

In accordance with another embodiment of the present invention, an image acquisition system is disposed to acquire images during the pick operation. Typical cameras found in pick and place machines, such as fiducial cameras, are downward looking and are physically blocked from acquiring an image of the pick position when the placement head is positioned above the pick position. In this embodiment, the camera is mounted on the placement head and its principle optical axis is angled with respect to the nozzle such that an image can be acquired at the same time as the component is being picked.

In accordance with yet another embodiment of the present invention, an image acquisition system is disposed to acquire image(s) during the pick operation of the area surrounding the pick position. Using such image(s), an image processing system determines a characteristic of the feeder mechanism used to present the component to the placement nozzle. Feeder mechanism characteristics that can be determined include feeder position; condition of the tape; proper indexing of the tape; identification of the feeder using marks (e.g. barcodes) or other forms of indicia; and feeder movement and vibration during the pick operation.

These and other advantages of aspects of the present invention will be apparent from the description below.

### BRIEF DESCRIPTION OF THE DRAWINGS

FIG. 1 is a diagrammatic view of a Cartesian pick and place machine with which embodiments of the invention can be practiced.

FIG. 2 is a diagrammatic plan view of a turret pick and place machine with which embodiments of the invention can be practiced.

FIG. 3 is simplified diagrammatic view of an image acquisition system aligned with a pick up point of a component placement machine.

FIG. 4 is a diagrammatic view of a pick and place machine with an attached image viewer disposed to display images and data relative to pick and/or placement operations.

FIG. 5 is a block diagram of the operation of the pick and place machine using image acquisition and display for setup.

FIG. 6 is an example screen image of the output display of the preferred embodiment of the invention.

FIG. 7 is a block diagram illustrative of a method of using a database to store placement information.

FIG. 8 is a diagrammatic view of a method of generating a pick indication in accordance with an embodiment of the present invention.

### DETAILED DESCRIPTION OF THE ILLUSTRATIVE EMBODIMENTS

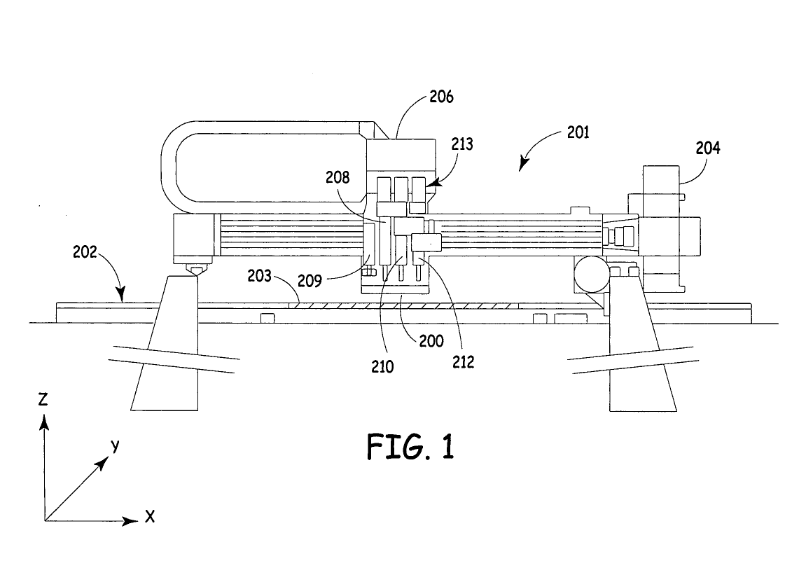

FIG. 1 is a diagrammatic view of an exemplary Cartesian pick and place machine 201 with which embodiments of the present invention are applicable. Pick and place machine 201 receives a workpiece, such as circuit board 203, via transport system or conveyor 202. A placement head 206 then obtains one or more electrical components to be mounted upon workpiece 203 from component feeders (not shown) and moves in x, y and z directions to place the component in the proper orientation at the proper location upon workpiece 203. Placement head 206 may include an alignment sensor 200 that may pass under components held by nozzles 208, 210, 212 as placement head 206 moves the component(s) from pickup locations to placement locations. Sensor 200 allows placement machine 201 to view undersides of components held by nozzles 208, 210, 212 such that component orientation and, to some degree, component inspection can be effected while the component is being moved from the component pick-up location to the placement location. Other pick and place machines may employ a placement head that moves over a stationary camera to image the component. The placement head 206 may also include a downwardly looking camera 209, which is generally used to locate fiducial marks upon workpiece 203 such that the relative location of placement head 206 with respect to workpiece 203 can be readily calculated.

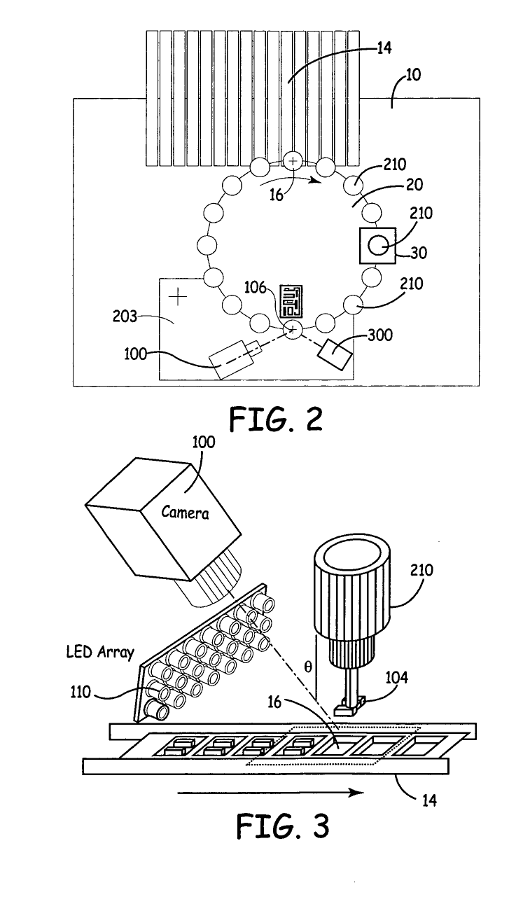

FIG. 2 is a diagrammatic view of an exemplary rotary turret pick and place machine 10 with which embodiments of the present invention are applicable. Machine 10 includes some components that are similar to machine 201 and like components are numbered similarly. For turret pick and place machine 10, workpiece 203 is loaded via a conveyor onto an x-y stage (not shown). Attached to main turret 20 are placement heads 210 that are disposed at regular angular intervals around the rotating turret. During each pick and placement cycle, turret 20 indexes an angular distance equal to the angular distance between adjacent placement nozzles 210. After turret 20 rotates into position and workpiece 203 is position by the x-y stage, a placement nozzle 210 obtains a component 104 (shown in FIG. 3) from a component feeder 14 at a defined pick point 16. During this same interval, another nozzle 210 places a component 104 onto the workpiece 203 at a preprogrammed placement location 106. Additionally, while turret 20 pauses for the pick and place operation, upward looking camera 30 acquires and image of another component 104, which provides alignment information for that component. This alignment information is used by pick and place machine 10 to position workpiece 203 when placement nozzle 210 is positioned several steps later to place component 104. After the pick and place cycle is complete, turret 20 indexes to the next angular position and workpiece 203 is repositioned in x-y direction(s) to move the placement location to position which corresponds to the placement location 106.

During initial setup of a pick and place machine, many parameters and variables should be configured and set correctly to ensure precise assembly of the workpiece. The following is a list of setup parameters that should be determined:
Types of components;
Types of feeders required to handle the components;
Location of the feeders within the pick and place machine;
Sequence program containing the order and position of component placements;
Nozzle type required for each component;
Size and design of the workpiece;
Position and type of fiducials on the workpiece;
Speed of placement for each type of component;
Vacuum pressure for each type of component;
Vertical stroke of nozzle;
Placement and selection of workpiece support pins;
Orientation of the workpiece;
Vision parameters for component alignment; and
Lighting parameters for component alignment.
   During the setup of the pick and place machine, an operator typically follows a procedure to load feeders into proper locations, load nozzles in a cassette, and assembles several workpieces using the appropriate placement program. After the first workpiece or group of workpieces is assembled, the operator inspects each workpiece visually or uses an automatic optical inspection system. If an error is found, the cause of the error is investigated and corrective action is implemented. As part of this initial setup of the pick and place machine, the position of the feeders, the component locations in the feeder, the amount of vacuum used to pick up the component, the height of the nozzle over the component when the vacuum is applied, and the component orientation and polarity are checked to determine if proper pick up of all components has occurred. After the corrective action is implemented, another group of workpieces are assembled and inspected. This cycle of assembly, inspection and corrective actions is repeated until the operator determines the pick and place machine is optimized or otherwise set correctly for production.

FIG. 3 is a diagrammatic view of a placement head in accordance with embodiments of the present invention. FIG. 3 illustrates image acquisition device 100 disposed to acquire images of pick up location 16 of component 104 before and after component 104 is picked up by nozzle 210 from location 16 in feeder 14. Device 100 obtains images of pick up location 16 on feeder 14 prior to pick up of component 104 and then shortly thereafter. A comparison of these before and after images facilitates component-level pick up inspection and verification. In addition, the area surrounding the component pick up location 16 is also imaged. Since acquisition of images of the pick up location 16 is generally done when the placement nozzle 210 is located above the pick up location 16, it is important to be able to image pick up location 16 while minimizing or reducing interference from component 104 itself or parts of placement nozzle 210. Thus, it is preferred that device 100 employ an optical axis allowing views that are inclined at an angle θ with respect to the axis of nozzle 210. An additional advantage of having device 100 inclined at an angle θ is that vertical motion of component 104; feeder; and component holding tape/tray can be detected and measured by determining the translation of these items between image acquisitions. It is also helpful to precisely time the image acquisition interval such that the pick up location 16 and the placement head 210 are relatively aligned with each other and that component 104 is visible in the feeder 14 from the camera angle. After component 104 is picked up, the second image should be timed such that it is at a pre-selected time during the pick up cycle. A method to precisely time the acquisitions of these two images is described in a co-pending application Ser. No. (10/970,355).

Embodiments of the present invention generally obtain two or more successive images of the intended pick up location (i.e. before pick up and after). Since pick up occurs relatively quickly, and since slowing machine throughput is extremely undesirable, it is sometimes necessary to acquire two successive images very quickly since cessation of the relative motion between the placement head and the pick up position is fleeting. For example, it may be necessary to acquire two images within a period of approximately 10 milliseconds.

In accordance with various aspects of the present invention, rapid acquisition of multiple successive images can be done in different ways. One way is using commercially available CCD devices and operating them in a non-standard manner to acquire images at a rate faster than can be read from the device. Another way is using multiple CCD arrays arranged to view the intended placement location through common optics. (As described in U.S. Pat. No. 6,549,647).

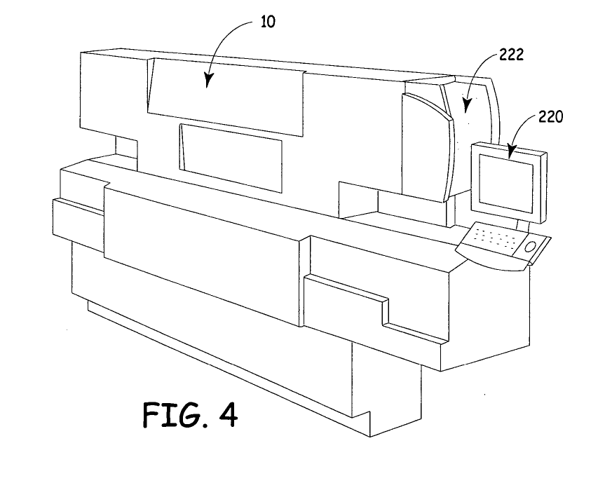

To be useful to the pick and place operator, images and data captured by the image acquisition device 100 should be coupled to, or provided with, a device to display the information. FIG. 4 shows one exemplary system providing such a display. Processor 222 and a monitor 220 are mounted on pick and place machine 10. The location of monitor 220 is chosen to provide the machine's operator with images and data gathered from image acquisition system 100 shortly after the pick up event. With images and data available to the operator during the assembly of the first board of a production run, the operator is able to make setup changes to the pick and place machine quicker than current practice.

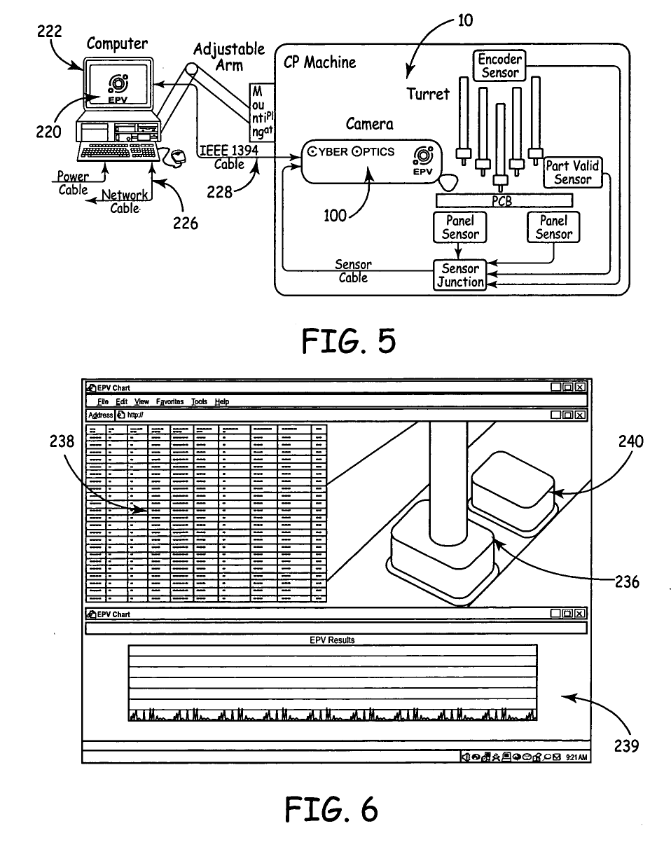

FIG. 5 is a block diagram illustrating operation of an embodiment if the present invention. Images acquired by the image acquisition system 100 are sent via common video interface 228 to processing system 222. One such video interface is the IEEE 1394 standard camera interface. Processing system 222 compares the before and after images to determine if the component was properly picked up on the nozzle. Processing system 222 can employ any suitable image analysis techniques, now known, or later developed to provide useful information about the component pick operation. For example, a known edge detection and location algorithm can be used within processing system 222 to generate orientation, position, size, and/or component presence information. Further, blur detection techniques can also be used to generate, or help generate, such information. Types of blur detection techniques that can be employed include Fourier Transform analysis and/or auto-correlation techniques. Further still, known Optical Character Recognition (OCR) techniques or pattern matching algorithms such as normalized gray scale correlation can be used to determine component polarity. Common defects that can be flagged are miss pick (no part picked), no parts in feeder, tombstoned or billboarded components where the component ends tipped up on its end or side after pickup, misregistered pick ups, wrong part orientation or polarity, excessive feeder or feeder tape vibration, incomplete feeder indexing, incorrect nozzle height at pick up, and excessive misregistration of components in the feeders. After processing system 222 has completed its tasks, the results are displayed on the monitor 220.

FIG. 6 is an example of the graphical output provided by system 222. Within the output, an image of the pick up site 240 is displayed. This image can be toggled between the before pick up image, the after pick up image and the difference image. Additionally, an indication of the quality of the pick up 236 can be added to the image as graphical aide to the operator. The results of the image processing are displayed in tabular form 238 allowing the operator to quickly review the results of the current pick up and placements and a history of previous pick up and placements. A graphical display of the feeder vibration 239 is shown in the lower portion of the screen. The vibration display can assist the operator by displaying the amount of pick up vibration present as a function of feeder. Additionally, the height of the nozzle over the component can be displayed. Using this height information, an operator can quickly determine if the pick height is properly set.

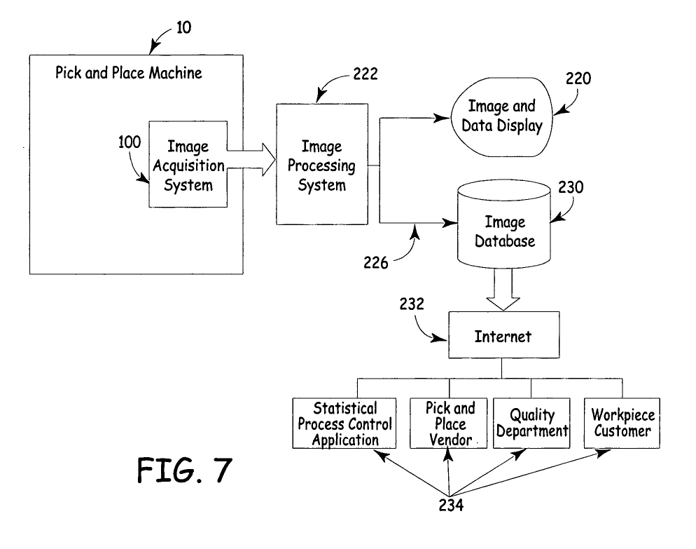

A further enhancement to this embodiment is shown if FIG. 7, which is a block diagram of the system previously described with the addition of a database server 230. In this embodiment, images and data are displayed on monitor 220 as before and the images and data are additionally sent to a database server 230 via a common interface link 226 such as an Ethernet communication link. Once the images and placement data are stored on the database server, the images and data can be queried and shared with other outside consumers 234 of the information. These consumers can include experts at the pick and place machine vendor's facility, statistical process applications and/or the final buyer of the assembled workpiece. Since these consumers are not typically located in the factory with placement equipment, data and images can be retrieved from the data base server 230 using familiar internet communications protocols 232.

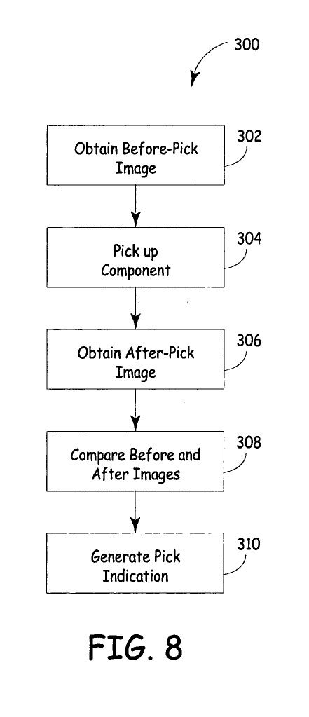

FIG. 8 is a diagrammatic view of a method of generating a pick indication in accordance with an embodiment of the present invention. Method 300 can be performed using any suitable image acquisition device disposed on the placement head, or otherwise. Further, any suitable image processing techniques, such as those set forth above with respect to FIG. 5) can be used to generate useful information from the acquired image(s). Method 300 begins at block 302 where a before-pick image of the component to be picked is acquired. The acquired before-pick image is stored in suitable storage media. Next, the pick and place machine executes the component pick operation, as indicated at block 304, by bringing a vacuum quill or nozzle proximate the component and applying vacuum to adhere, or otherwise attach, the component to the nozzle/quill. Once the component has been picked up, an after-pick image is acquired of the pick location where the component was disposed prior to the pick operation. As set forth above, the field of view of the before- and after-pick images can be just the area occupied by the component or it can be broader encompassing a selected area around the component. At block 308, the before- and after-pick images are compared. This comparison can be done by generating a difference image based on the two images, or it can be done by providing both images to a display and receiving an input from a technician based on the technician's visual comparison. Other techniques for manipulating the images to highlight, or otherwise focus upon, differences between the two images can be used in accordance with embodiments of the present invention. Additionally, image analysis techniques can be applied to either or both before- and after-pick images to generate or compute a parameter of interest relative to the pick operation. For example, one or both images can be analyzed to determine if there is any blur in the image. If blur is present, it can be measured, with known techniques, and the degree of blur can be used to provide an indication of relative motion between the pick location and the placement head. At block 310, a pick indication is provided. Such indication can include providing information to a technician, or the pick and place machine, that the pick was successful. However, the pick indication can also include error information such as the presence and absence of a component to be picked in the correct pick position; the presence or absence of a component on the nozzle after pick; the correct orientation and polarity of the component before pick up; the correct position of the component after pick on the nozzle; the condition of the nozzle; the height of the nozzle at the time of component pick up; and the condition and movement of the feeder during the pick operation. Further, the pick indication can include combinations of such information. Finally, the pick indication can also include feeder information such as a characteristic of the feeder mechanism used to present the component to the placement nozzle. Feeder mechanism characteristics that can be determined include feeder position; condition of the tape; proper indexing of the tape; identification of the feeder using marks (e.g. barcodes) or other forms of indicia; and feeder movement and vibration during the pick operation.

Although the present invention has been described with reference to preferred embodiments, workers skilled in the art will recognize that changes may be made in form and detail without departing from the spirit and scope of the invention.

What is claimed is:

1. A pick and place machine for assembling a workpiece, the machine comprising:
a placement head having at least one nozzle for releasably picking up and holding the component;
a robotic system for generating relative movement between the placement head and the workpiece;
a image acquisition device disposed to obtain at least one image of a component pick up location; and
an image processing device for analyzing the at least one image generated by the image acquisition device to determines at least one characteristic of the component pick up process.

2. The pick and place machine of claim 1, wherein the at least one characteristic includes absence of the component to be picked in a correct pick position.

3. The pick and place machine of claim 1, wherein the at least one characteristic includes absence of the component on the at least one nozzle after pick.

4. The pick and place machine of claim 1, wherein the at least one characteristic includes correct orientation of the component before pick up.

5. The pick and place machine of claim 1, wherein the at least one characteristic includes polarity of the component before pick up.

6. The pick and place machine of claim 1, wherein the at least one characteristic includes correct position of the component after pick on the nozzle.

7. The pick and place machine of claim 1, wherein the at least one characteristic includes a condition of the nozzle.

8. The pick and place machine of claim 1, wherein the at least one characteristic includes height of the nozzle at the time of component pick up.

9. The pick and place machine of claim 1, wherein the at least one characteristic includes condition of a feeder containing the component during a pick operation.

10. The pick and place machine of claim 1, wherein the at least one characteristic includes movement of a feeder containing the component during the pick operation.

11. The pick and place machine of claim 1, wherein:
the image acquisition device is disposed to obtain a before image of the component pick up location before pick up of the component and to obtain an after image of the component pick up location after the pick up of the component;
the image processing device compares the two images obtained by the image acquisition device; and
the image processing device determines at least one characteristic of the component pick up process based on the comparison.

12. A pick and place machine for assembly of a workpiece, the machine comprising:
a placement head having at least one nozzle for releasably holding the component;
a robotic system for generating relative movement between the placement head and the workpiece;
a image acquisition system disposed to obtain an image of a pick up location of a component;
a trigger mechanism disposed to detect the position of the placement head during a pick up cycle; and
wherein the image acquisition system is triggered at selected intervals to generate a sequence of images of the pick up cycle.

13. The system of claim 12, wherein the images are acquired during the pick up of a single component.

14. The system of claim 12, wherein the images are acquired during the pick of several components.

15. A method of picking up a component during a pick and place operation the method comprising:
capturing an image of a component before it is picked up by a pick and place machine;
capturing an image of the component at least once after the component is picked up;
comparing the image acquired before pickup and the image acquired after pick up to determine a characteristic of the pick up operation;
generating a pick indication based upon the comparison.

16. The method of claim 15 and further comprising:
sensing motion blur of at least one of the images; and
detecting an amount of motion from the sensed blur.

17. A method for programming a pick and place machine to assemble a workpiece the method comprising of:
acquiring at least one image of a component pick up operation;
displaying at least one image of a component pick up operation; and
adjusting at least one parameter of the pick and place program using the displayed image.
